(19) United States
(12) Patent Application Publication
(10) Pub. No.: US 2003/0204371 A1
(43) Pub. Date: Oct. 30, 2003

(54) Temporary wireless sensor network system

(75) Inventor: Steven F. Sciamanna, Orinda, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 10/427,192

(22) Filed: Apr. 30, 2003

Related U.S. Application Data
(60) Provisional application No. 60/377,376, filed on Apr. 30, 2002.

(51) Int. Cl. G06F 11/30; G06F 15/00; G21C 17/00; G06F 11/00

(52) U.S. Cl. 702/183

(57) ABSTRACT

The invention is an integrated temporary wireless network system for controlling, collecting, processing, and responding to data generated by a plurality of sensors configured for measuring data associated with operation of, and the environment related to, commercial, industrial and manufacturing operations, processes and equipment located within a fixed geographic area; a plurality of Wireless-Nodes, one coupled to each sensor, configured and adapted for wirelessly transmitting the data, via a Repeater if necessary, to a Base-Station, configured for receiving the data and connected to a primary computer; a CPU coupled with the primary computer and; a memory operatively connected to the CPU, the memory containing a program adapted to be executed by the CPU and the CPU and memory cooperatively adapted to perform data flow control from the plurality of Wireless-Nodes, data storage, and diagnostic analysis of the transmitted sensor data.

### I. COPYRIGHT NOTICE AND AUTHORIZATION

This patent document contains material which is subject to copyright protection.

© Copyright 2002-2003. Chevron U.S.A. Inc. All rights reserved.

With respect to this material which is subject to copyright protection. The owner, Chevron U.S.A. Inc., has no objection to the facsimile reproduction by any one of the patent disclosure, as it appears in the Patent and Trademark Office patent files or records of any country, but otherwise reserves all rights whatsoever.

### II. FIELD OF THE INVENTION

This invention relates to a system for monitoring, facilitation of trouble-shooting and problem diagnosis in commercial, industrial and manufacturing operations, processes and equipment, (collectively referenced hereinafter as “Industrial Process”).

### III. BACKGROUND OF THE INVENTION

Oil and gas processing, petroleum refining and chemical processing plants and many other processing, commercial and manufacturing industries currently utilize various automated control systems. Such systems in use include distributed process-control systems (“DCS”) and Supervisory Control and Data Acquisition Systems (“SCADA”). Such systems or related systems are commercially available, e.g., from Honeywell, Yokogawa, Rockwell, Invensys, Emerson, Triconix, Tyco and OSI.

These systems include permanent sensors on process units or process streams for measuring relevant parameters such as temperature, pressure, flow rate, level, power consumption, or composition; a network for transferring the collected data to a central processing unit and database; software for monitoring and displaying sensor values and for controlling various valves and other devices associated with a process unit or equipment to maintain the relevant parameters within desired ranges; optionally a data historian for storing and reporting the sensor data in a usable format to other diagnostic systems.

There are two general sensor related issues commonly found in process plants. First, process plants are generally instrumented for normal operation and not for detailed trouble-shooting. When everything is working fine, there is often too much data and it is discarded but when the process is not working properly then often there is not enough data to identify the root cause of the problem. Hence there is a need for a temporary sensor system for real-time, on-line analysis.

Second, justifying the hardwiring of a new sensing location, or new sensor type, is often not possible unless you can a priori prove its value, but you can't prove the value until you have the data. A temporary wireless sensor network enables the end-user to build the business case and justify, or not, the permanent installation of a new sensor type or sensing location.

The two issues described above are the basis of the two “use cases” for the present invention. The first “use case” addresses the deployment of temporary sensors for troubleshooting and optimization. The second “use case” addresses the deployment of temporary sensors to identify where the installation of new permanent sensors (locations or types) would add business value.

Trouble-shooting & Diagnosis: When a problem arises with a process unit that cannot be readily diagnosed, corrected and/or optimized with the data collected from existing permanent sensors, it is desirable to add more sensors and gather additional data on the operation of the unit. The data from these added sensors can be analyzed alone and often that is sufficient to solve the problem. However, it is often desirable to integrate this additional data with the existing data collected by the process-control system and then analyze the combined data set.

However, it would be unduly expensive to permanently install such additional sensors to all process units or streams without regard to whether the units are experiencing problems. The value of this additional data is not clear under normal operations and, in practice, this extra data can be an annoyance. It would be advantageous to have a trouble-shooting kit of sensors that could be temporarily installed on a unit experiencing problems, together with necessary wireless data nodes, a base station, a data-storage and data-acquisition control computer and software for analyzing this data alone or in conjunction with the existing process-control system collected data.

After the problem is solved the added sensors are removed and the temporary wireless sensor network system can be re-deployed elsewhere.

Justification of New Sensors and Sensing Locations: Testing a new type of sensor or adding an existing sensor type to a new sensing location can have a considerable expense and delay associated with it. Determining the business value of a new sensor type or sensor point is often difficult without already having the data collected from the new sensor. A temporary means for deploying such sensors, with minimal cost and delay, can provide the justification (or not) for incurring the expense of the permanent installation of a new sensor type or a new sensing location (whether it has “wired” or “unwired” data communication).

Industries, businesses, processes, and equipment in fields other than the refining and chemical industry also have a need for such a solution. For example this need also exists in power utilities, waste and water treatment plants, surface mining and defense-related applications.

This invention provides such a solution.

### IV. SUMMARY OF THE INVENTION

The invention includes a method for monitoring, facilitation of trouble-shooting and problem diagnosis in an Industrial Process (as defined above). The method includes installing a plurality of temporary, removable sensors on an Industrial Process; collecting operational or environmental data associated with the Industrial Process via the plurality of sensors; communicating the data from the sensors to a Wireless-Node for transmitting the collected data; communicating the data from the Wireless-Node to a Base-Station located remotely from the sensors; communicating the data to a general-purpose computer having loaded in memory computer software code portions for controlling the flow of data from the Wireless-Nodes and for storing, querying, reporting, visualizing and analyzing the data for relationships or anomalies among the data; and removing the plurality of sensors from the Industrial Process.

In an alternate embodiment, the invention includes a method for evaluating the need and/or benefit for new permanent data sensors and/or sensing locations in an Industrial Process. The method includes installing a plurality of temporary, removable sensors on an Industrial Process; collecting operational or environmental data associated with the Industrial Process via the plurality of sensors; communicating the data from the sensors to a Wireless-Node for transmitting the collected data; communicating the data from the Wireless-Node to a Base-Station located remotely from the sensors; communicating the data to a general-purpose computer having loaded in memory computer software code portions for controlling the flow of data from the Wireless-Nodes and for storing, querying, reporting, visualizing and analyzing the data; assessing the benefit or business value of the temporary sensors or alternate sensing locations; and removing the plurality of sensors from the Industrial Process or its related hardware. Optionally, this and other embodiments include installing one or more permanent sensors corresponding to one or more of the temporary sensors or sensing locations.

Another embodiment of the invention includes a system for monitoring, facilitation of trouble-shooting and problem diagnosis of Industrial Processes including: a plurality of sensors configured for measuring data associated with an Industrial Process, wherein each sensor is temporarily connected to an Industrial Process; at least one Wireless-Node, optionally one coupled to each sensor, configured and adapted for transmitting the data, directly or via Repeaters (i.e., intermediary transceivers), to a central Base-Station, configured for receiving the data transmitted and for sending the data to a general-purpose computer; a general-purpose computer having data storage capability and computer software programs for data storage and for controlling data flow from the Wireless-Nodes (and Repeaters) and to perform pre-processing of the collected data for further processing.

An alternate embodiment of the invention includes a data processing system for collecting, processing, and responding to a plurality of data generated by a plurality of Industrial Processes located within a fixed geographic area, including: a plurality of sensors for collecting operational or environmental data associated with an Industrial Process unit, where each sensor is temporarily connected to an Industrial Process unit, stream, or related hardware; each sensor is connected to a Wireless-Node which contains signal conditioning and processing circuitry combined with a transceiver for transmitting the collected data; to a central Base-Station, configured for receiving the data transmitted and for sending the data to a primary computer; a CPU coupled with the primary computer and; mass data storage operatively connected to the CPU and; active memory operatively connected to the CPU, the active memory containing programs for controlling the data communication from the Wireless-Nodes, for storing data collected from the sensors and to perform diagnostic analysis of the collected data.

Optionally, the aforementioned computer, or a separate computer connected to the former via a network link, which has access to data collected by the existing process-control system, if there is one, and which also has loaded in memory computer software code portions for storing, monitoring, querying, visualizing and analyzing the aggregated data for relationships or anomalies among the collected data; reporting and notification of relationships or anomalies or fault conditions.

Another alternate embodiment of the invention includes a method for monitoring, facilitation of trouble-shooting and problem diagnosis in commercial, industrial and manufacturing operations, processes and equipment (“Industrial Process”) including: collecting operational or environmental data associated with an Industrial Process unit via a plurality of sensors, where each sensor is temporarily connected to an Industrial Process unit or related hardware; sending the signal from the sensors to one or more Wireless-Nodes; communicating the data from the Wireless-Nodes to a central Base-Station located remotely from the sensors, and for passing it over a wired connection to a first general purpose computer having loaded in memory computer software code portions for controlling the data communication from the Wireless-Nodes, collecting and storing the data from the sensors; and communicating via a network link from the first general purpose to a second general purpose computer having loaded in memory computer software code portions for collecting data from an existing wired process-control system, thereby producing an aggregated data and for storing, querying, reporting, visualizing and analyzing the aggregated data for relationships or anomalies among the aggregated data.

Another alternate embodiment of the invention includes a method for collecting, processing, and responding to a plurality of data generated by a plurality of pieces of industrial equipment located within a fixed geographic area, including: measuring data useful for operating pieces of industrial equipment via plurality of wireless sensors; wirelessly transmitting the data via a plurality of Wireless-Nodes, one coupled to each sensor, optionally via Repeaters (i.e. intermediary transceivers), receiving the data by a Base-Station; and communicating the data via a wired connection to a primary computer including a CPU coupled with the primary computer and a memory operatively connected to the CPU, the memory containing one or more programs adapted to be executed by the CPU and the CPU and memory cooperatively adapted to perform control of data flow from the Wireless-Nodes, storage of sensor data and diagnostic analysis of the data communicated from the base station.

Another embodiment of the invention includes a temporary wireless sensor network and diagnostic system including a plurality of removable sensors; a temporary wireless network means for connecting said plurality of removable sensors with an existing network; an integration means for integrating sensor data from said removable sensors with data from existing sensors, to form aggregated data, wherein said existing sensors are connected with said existing network.

In other embodiments the invention include other systems configured and adapted to perform the steps listed in the above-described methods, and computer readable media containing computer readable instructions configured and adapted to perform or assist in one or more of the steps listed in the above-described methods.

These and other features and advantages of the present invention will be made more apparent through a consideration of the following detailed description of a preferred embodiment of the invention. In the course of this description, frequent reference will be made to the attached drawings.

### V. BRIEF DESCRIPTION OF THE DRAWINGS

FIG. 1 is a schematic block system diagram of one embodiment of the invention.

FIG. 2 is a schematic diagram showing the use of temporary sensors to diagnose a process-equipment unit in one embodiment of the invention.

FIG. 3 is a schematic block system diagram of an expanded view of the sensor and Wireless-Node configuration in one embodiment of the invention.

FIG. 4 is a schematic block system diagram of the optional Repeater configuration in one embodiment of the invention.

FIG. 5 is a schematic block system diagram of the Base-Station, associated equipment and data integration configuration in one embodiment of the invention.

### VI. DETAILED DESCRIPTION OF PREFERRED EMBODIMENTS

A. Introduction

The following discussion and figures include a general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote memory storage devices.

Then invention generally relates to a system for diagnosing problems in process or manufacturing equipment or processes and for testing a new sensor type, or a new sensing location, to determine its value without the expense or delay of permanent installation. Referring now to the drawings, in which like numerals represent like elements throughout the several figures, aspects of the present invention and a suitable operating environment will be described.

The invention is a Temporary Wireless Integrated Network System (TWINES™). It is a portable tool for use in the real time, on-line analysis of process and equipment performance. TWINES™ enables rabid trouble-shooting, facilitates the identification of system performance improvements, and assists in building the business case for new sensor types or new sensing locations. The use philosophy of the TWINES™ tool is based on the temporary deployment (a few weeks) of a variety of user-determined sensor types. These sensors supplement the existing data collected to provide a (more) complete analysis of process performance, equipment status and re-conciliation of inconsistent information. The purposes for collecting this better information include anticipating equipment failures, increasing production, improving product quality and identifying root causes for failure.

The main features of the TWINES™ tool are it is: easy to set-up and use (“plug and play”), sufficiently robust for field use, portable, designed to meet intrinsic-safety criteria for hazardous locations, remote devices are battery-powered, and the additional data provided can be analyzed by itself or easily integrated with data from an existing data collection system and the aggregated data is analyzed.

B. System

The system (TWINES™) consists, in one embodiment, of the following components:

a variety of user-selected sensors with suitable output signals

Wireless-Nodes containing circuitry that convert sensor output signals into suitable data protocol for transmission and also have (2-way) transceivers which transmit data and receive instructions regarding control of data flow.

Optionally Repeaters (one or more) for communicating data from Wireless-Nodes over a larger distance.

a base-station transceiver for communicating with the Wireless-Nodes

a primary computer connected to the Base-Station for controlling data flow, storing sensor data, and optionally containing data analysis software

a computer network connected to the primary computer

optionally, software programs which integrate any data from an existing data collection system and data from the temporary sensor network, software programs for data analysis, visualization and diagnostics on any computer on or off the same network as the primary computer.

As discussed in this specification, subsets of the above components are also within the scope of the invention, e.g., where no optional Repeater, wired or wireless networks connected to the primary computer, and/or no inclusion of a diagnostic system.

The sensor components are preferably designed for “plug and play” use and a standard connection is made to the Wireless-Node. Preferably the sensors are non-invasive (e.g., contact thermocouple) or use existing process access points (e.g., sample taps and vent points) or measurement points (e.g., a local TI thermowell). They can be held in place by any conventional means such as threaded connection, straps, Velcro, magnets or duct tape. Power is principally supplied to the Wireless-Nodes via internal, rechargeable batteries. Where required due to the environment, all field mounted devices (i.e., sensors, Wireless-Nodes, Repeaters) are designed to be weather-proof and meet the “intrinsic-safety” criteria for hazardous locations. This is a necessary system feature for hazardous locations otherwise heavy and bulky explosion-proof enclosures would be needed and this would be counter to the portability aspect of the invention.

Preferably, Repeaters (one or more) are mounted in safe locations. The method of power supply depends on the environment the Repeater is placed. Repeaters are powered from an AC power source or optionally powered by a battery/solar device. Optionally, the Repeater can communicate directly to a portable computer, or via the Base-Station, to aid in local configuration of the system during sensor deployment.

TWINES™ includes, in one embodiment, a suite of standard diagnostic tools for data analysis and can be augmented with specialty diagnostic tools for a specific application.

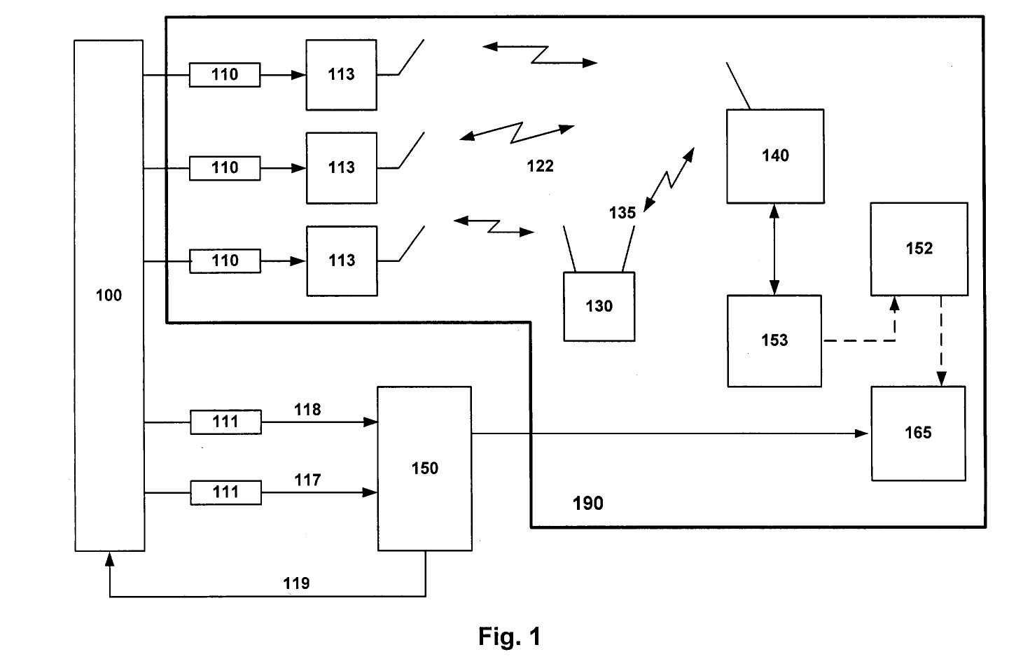

FIG. 1 is a simplified schematic diagram of one embodiment of the invention. A temporary sensor 110 is connected to a process stream or equipment 100. Sensor 110 is connected to a Wireless-Node 113 over a guided media (e.g., wire). The Wireless-Node 113 is configured for communication with Base-Station 140, optionally via Repeater 130 over an unguided media. Optional Repeater 130 is configured for communication with Base-Station transceiver 140 over an unguided media. Base-Station 140 is connected to primary computer 153. Primary computer 153 provides; data communication control from multiple Wireless-Nodes; provides sensor data storage 152 or optionally data store 152 can be associated with another computer linked to the primary computer; and optionally provides data analysis and diagnostic software 165. The above-described components make-up a temporary wireless network system as shown by box 190.

The TWINES™ system is optionally configured to cooperate with legacy systems. As shown in FIG. 1, legacy sensors 111 are also connected to process or equipment 100. Legacy sensors 111 are connected via guided media to legacy control system 150. Legacy sensor 111 data is stored within legacy control system 150. Diagnostic software 165 aggregates legacy sensor 111 data with temporary sensor data store 152 for analysis.

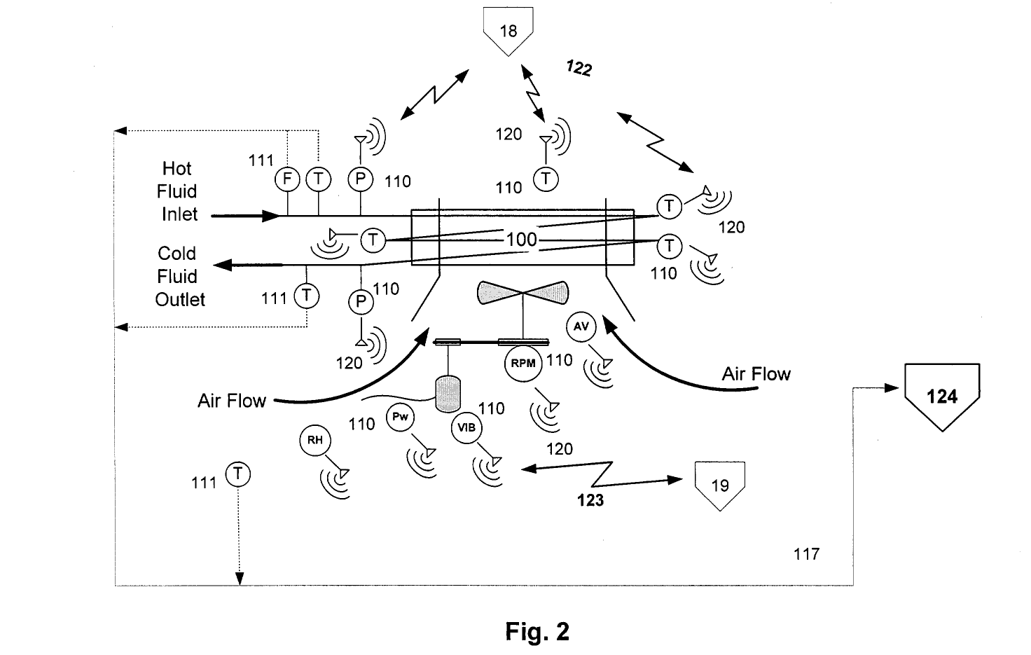

FIG. 2 is a schematic diagram showing the use of temporary sensors to diagnose a process-equipment unit in one embodiment of the invention. Each element involved in the system, in one embodiment, is depicted in this figure and others). For this example, an air-cooled heat exchanger 100 is the subject process-equipment unit being diagnosed. Temporary additional sensors 110 are temporarily connected with process or equipment 100 and are connected to Wireless-Nodes 120. The connection is by standard methods known in the art. The sensors 110 are configured to measure data of interest related to air-cooled heat exchanger. These data are, temperature (T), pressure (P), air velocity (AV), relative humidity (RH), vibration (VIB), rotational speed (RPM) and electrical power (Pw) in/at/around different locations in the equipment. Such sensors are commercially available.

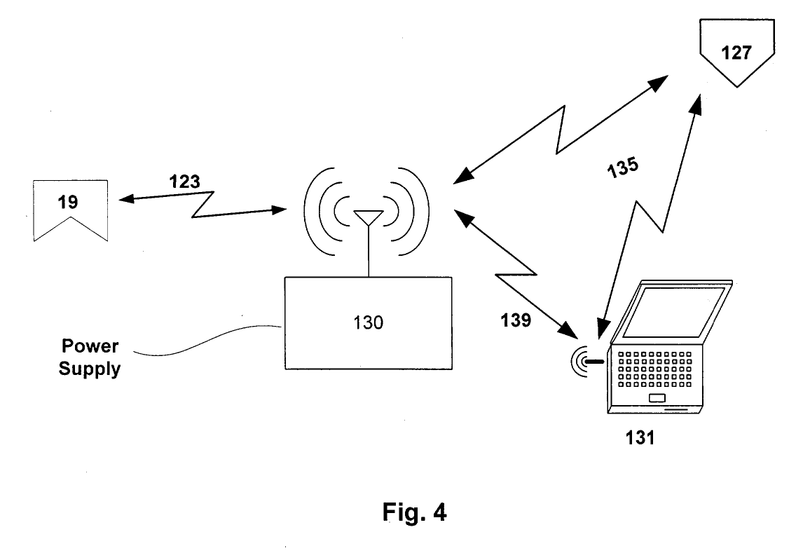

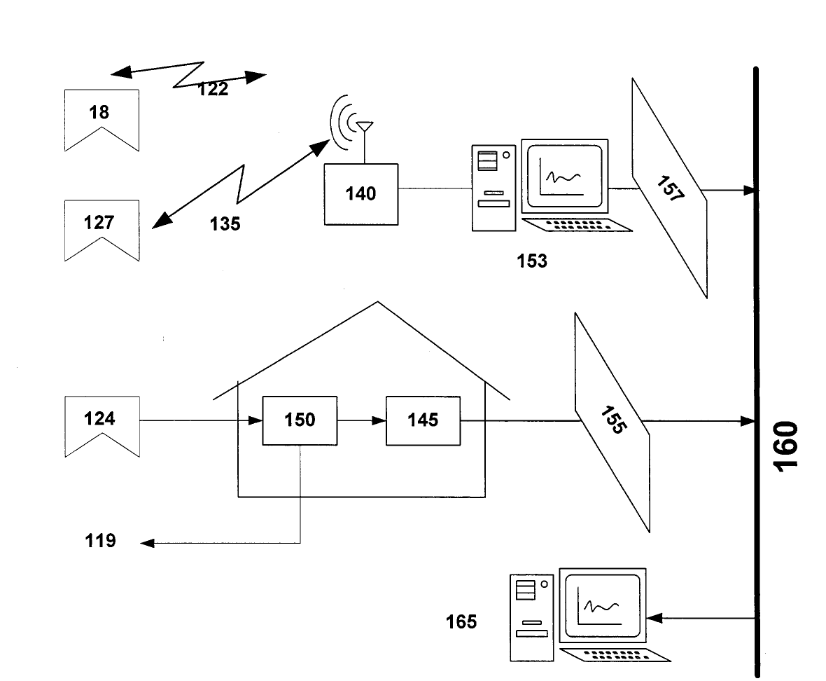

A sufficient number and type of sensors are deployed to achieve the desired goals of process monitoring, trouble-shooting and problem diagnosis of heat exchanger 100. Other uses are possible and within the scope of the invention. The range of these Wireless-Nodes is ideally sufficient to transmit a signal 122 via unguided media to Base-Station 140 (follow off-page reference 18 to FIG. 5,). If the range is not sufficient then signal 123 can be re-transmitted via repeater 130 (follow off-page reference 19 to FIG. 4,). In this example, sensors 111 are legacy sensors connected via guided media 117. The path of guided media 117 is shown on FIG. 5 by following off-page references 124. The invention is not limited to requiring only one hop of unguided transmissions.

That is, the number of hops of unguided transmission media is dependent on the site terrain, transmission distance, physical obstacles and on the power output of the Wireless-Node. Where unguided media requiring line-of-site are used the number of unguided hops depends on what is necessary to reach the destination via line-of-sight. Ideally, one is sufficient, but two or more may be needed for some or all of the Wireless-Nodes.

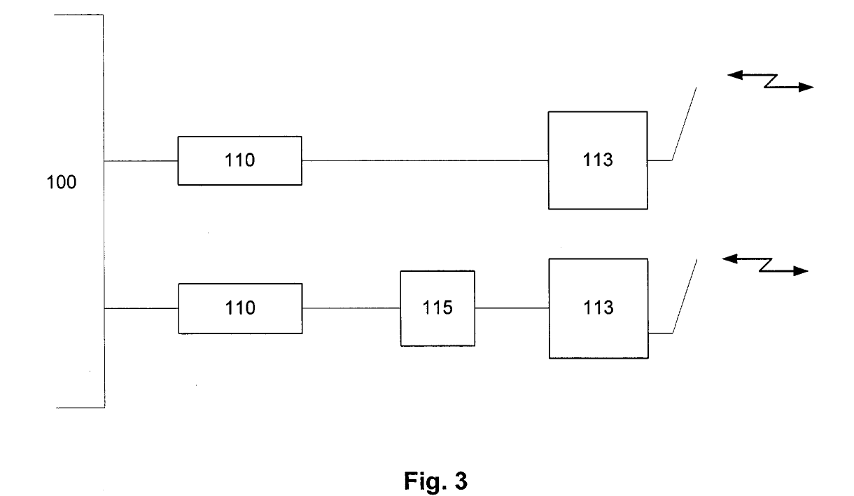

FIG. 3 is a schematic block system diagram of an expanded view of the sensor(s) and Wireless-Node configuration in one embodiment of the invention. Sensors 110 are connected to a Wireless-Node 113 via a standardized connector. Optionally, if needed, a connector adapter 115 may be needed to facilitate the guided connection. Such an adapter 115 can be either commercially available or can be constructed using conventional methods from conventional equipment by one of ordinary skill in the hardware engineering arts.

Sensors have a variety of output signals. Some are analog (e.g., thermocouple) with many different signal forms possible (e.g., μV, mV, V, mA), while others are already in a digital format (e.g., RS-232, RS-485). In addition, some sensors require an input excitation voltage (e.g., pressure transducers) and some sensors have their own internal power source. For those sensors that provide an analog output, their signal must be conditioned and digitized to provide a digital format that can be related to the measurement taken and also a suitable protocol for manipulation and transmission.

For such a sensor 110 and optional connector adapter 115, the Wireless-Node provides any necessary signal conditioning, analog-to-digital conversion (if needed) and transmission using a standard wireless protocol for unguided transmission or suitable protocol guided transmission. Low power, low bandwidth transmission methods (e.g. radio-based devices) are preferred to extend battery life and thus limit the size and weight of the Wireless-Node. This is particularly preferable in environments requiring the Wireless-Node must be designed as “intrinsically-safe”. To obviate the need for bulky “intrinsically-safe” power connections, the battery should be enclosed within the Wireless-Node. Where intrinsic safety and power supply are not issues then it is possible to use other power-demanding protocols such as wireless Ethernet (e.g., 802.11 b)

Although it is possible to design Wireless-Node 113 to accept multiple sensor 110 signal inputs, the preferred mode is one sensor 110 per Wireless-Node 113 in environments where an intrinsically safe design is required. One safety consideration is the need for channel-to-channel isolation circuitry. The continuous power drain of such circuitry decreases battery life. Each sensor 110 and Wireless-Node 113 is to be uniquely identified with any data transmission.

FIG. 4 is a schematic block system diagram of the Repeater configuration in one embodiment of the invention. The function of one or more Repeaters 130 is to forward the signals received from the Wireless-Nodes 113 for a distance sufficient to reach Base-Station 140 via unguided media 135 (follow off-page reference 127 to FIG. 5) and to forward communication control instructions from the Base-Station 140 to the Wireless-Node 113. For safety and security preferably transmissions between Wireless-Node 113, Repeaters 130, and Base-Station 140 are via a secure means. Such means can be encryption or proprietary protocols and others.

A portable computing device 131 such as a notebook computer, personal digital assistant, or other such device is optionally used for wired or wireless communication signal 139 with the Repeater 130 or with the Base-Station 140 via unguided media 135 (follow off-page reference 127 to FIG. 5) or via unguided media 122 if the signal strength is sufficient. This could be used by a person such as an engineer in the field to facilitate system set-up or trouble-shooting or other goals of using the system.

FIG. 5 is a schematic block system diagram of the Base-Station, associated equipment and data integration configuration in one embodiment of the invention. Base-Station 140 is in 2-way communication with one or more Wireless-Nodes 113 and optionally via Repeaters 130; using unguided signals 135, 136, and 137 (follow off-page reference 127 to FIG. 2). Base-Station 140 is in guided communication to primary computer 153 which is in guided communication with intranet 160, optionally via a firewall 157 or other security device. Primary computer 153 acquires and stores transmitted data from all sensors 110 within a database structure. In addition, primary computer 153 executes data acquisition software for controlling the communication of data from the Wireless-Nodes 113. Optionally, data from legacy sensors 111 are passed to the data historian 145 within process-control system 150 (follow off-page reference 124 to FIG. 1). The data historian 145 is accessible via intranet 160, optionally via a firewall 155 or other security device. One or more computing devices 165, such as, personal computer, workstation, or other device, are also in communication with intranet 160.

The primary computer 153 or computing device 165 optionally includes preprocessing means (not shown) for preprocessing said integrated data for further processing. The further processing optionally includes means for providing notification regarding an occurrence of an event (not shown); transmitting a portion of said integrated data to a data interpretation system; and/or means for initiating follow-on actions (not shown). The follow-on actions optionally includes correction means (not shown) responsive to an event. The above-described means can be configured in software and/or hardware by those of ordinary skill in the art.

Computing device 165 has installed thereon, or access to via the intranet 160, one or more diagnostic tools configured to receive the data transmitted from the legacy and the removable sensors, perform some analysis on it, report findings (e.g., anomalies, problem areas), diagnose the operational state of processing equipment, or otherwise assist in trouble shooting or other goals of using the system. Such diagnostic tools may use methods such as temporal trending or cross-plotting, data visualization for pattern recognition, data reconciliation using “physical” computer model simulations, automated analysis and reporting, and anomaly detection.

C. Method

The method/process aspect of the invention is a series of process steps utilizing, in whole or in part, the above-described system and variations thereof. As would be clear to one skilled in the art, the process steps can be embodied in part as code for a computer program for operation on a conventional programmed digital computer, such as a client and server. The program code can be embodied as a computer program on a computer-readable storage medium or as a computer data signal in a carrier wave transmitted over a network.

With reference to Figures, data is collected from sensor arrays 110, passed to optional connector adapters 115, passed to Wireless-Nodes 113, passed to optional Repeaters 130, passed to Base-Station 140, passed to primary computer 153, optionally together with legacy sensor data from legacy sensors 111 and legacy control system 150, to diagnostic system 165. The invention also includes sub-portions of this method, e.g., the step of installing the temporary sensors 110 and passing collected data to Base-Station 140 by whatever means. Also, another aspect of the invention which is a sub-portion of the above-described method is receiving at Base-Station 140 data from sensors 110, passing and storing this data in primary computer 153, passing, some or all of, the data to computing device 165 and integrating this data within computing device 165 with legacy sensor data passed from the data historian within a legacy control system 150.

D. Illustrative Functional Specification

An illustrative, simplified functional specification for implementing one embodiment of the invention is provided below.

1. Illustrative Sensors

Depending on sensor type, sensors are preferably designed for “Plug & Play” use and have a standard connection. Ideally the only information that the user would need to input is an identifier for each sensor type which has pre-programmed configuration parameters stored within the system, as well as, sampling and transmission protocol. Sensors in certain environments must be designed as “Intrinsically Safe”, have weatherproof enclosures, rugged construction for field use, and be able to accommodate different mounting systems.

Preferable, sensors are either non-invasive or use existing process access points (e.g., sample taps and vent points) or measurement points (e.g., a local TI thermowell). They can be held in place by threaded connection, straps, Velcro, magnets or duct tape. A sensor can have pre-programmed calibration characteristics supplied by a vendor that are stored in memory within the Wireless-Node or within the primary computer. Optionally, sensors can be field calibrated and their calibration characteristics are also stored with date and time of last calibration.

In addition to previously listed sensors, the types of sensors include but are not limited to the following: temperature (e.g. thermocouple, resistance temperature device, infrared), pressure, flow, relative humidity, vibration, light, sound, rotational speed, voltage, current, power, corrosion rate, contact closures and composition sensors (e.g. ion specific electrodes, pH, ORP, electronic “smell”). Some of these sensors provide only an analog output and others provide a digital output.

2. Wireless-Nodes

In order to make either of these sensor types suitable for use in the envisioned system they must be coupled to a multi-function Wireless-Nodes. The Wireless-Node is capable of (1) taking a variety of voltage or current output signal levels from an analog sensor, performing signal conditioning (i.e., amplification or reduction), performing analog-to-digital conversion and converting it to a digital protocol or (2) in the case of an already digital output sensor, converting that command set to a common digital protocol as in case (1).

All sensors with adapters, if necessary, have standard connections with a Wireless-Node. Ideally the only information that the user would need to input is an identifier for each sensor tagged to the particular Wireless-Node to which it is connected. Sensors and Wireless-Nodes must be designed as “Intrinsically Safe”, have weatherproof enclosures, rugged construction for field use and can accommodate different mounting systems.

Wireless-Nodes have non-removable, internal, batteries that are re-chargeable via a suitably protected access connection on the Wireless-Node. In some cases, the Wireless-Node can also provide the power source to an individual sensor (e.g., pressure) if its power requirement is sufficiently low. The Wireless-Node communicates (2-way) over a distance with the Base-Station. This distance depends on the terrain, obstructions and transmission power output of the transceiver in the Wireless-Node. The Base-Station is networked with the other Wireless-Nodes (or Repeaters described below) so that there are no communication collisions.

3. Illustrative Repeater Device

The Repeater provides 2-way communication between some or all of the Wireless-Nodes and the Base-Station. Multiple Repeaters can be used depending on the overall distance required, terrain, obstacles and transmission power output of both the Wireless-Node and the Repeater. Optionally, the Repeater can communicate via wireless connection to a portable computer to aid in local set-up. Preferably the Repeater is located in a non-hazardous location and accessible to a suitable power source or by a battery/solar power device.

4. Illustrative Base-Station, Primary Computer & Network Integration

The Base-Station transceiver can communicate with multiple Wireless-Nodes and multiple Repeaters simultaneously, is connected to a primary computer which is in turn is connected to the information network. These devices are mounted in a safe location, with access to a suitable location for an antenna, convenient to a network connection and a power source. The Base-Station acquires the data from the various Wireless-Nodes and Repeaters in service. The data collected and stored in the primary computers in a suitable format (e.g., database) for integration with other data sources (e.g., process-control system data historian or Laboratory Information Management System-LIMS) by software residing on the primary computer or a diagnostician's computer attached to an intranet.

5. Illustrative Diagnostic Tools

TWINES™ includes a suite of standard diagnostic tools for data analysis (e.g., spreadsheets, temporal trending, cross-plotting) and can be augmented with specialty diagnostic tools for a specific application. In addition to tools listed above, these tools may include process unit analysis software (e.g., heat exchangers, distillation columns), data mining and visualization software and tools which integrate process models (e.g., HYSIS™) with the collected data.

6. Illustrative Application

Applications which benefit from additional sensors on a temporary basis optionally include; Start-Up & Shut-Down of processes and process equipment, process monitoring and optimization, process and equipment troubleshooting, maintenance-status assessment, temperature profiling during vessel heat-treatment, environmental or hazard monitoring during maintenance operations and assessing the value and efficacy of a new sensor type or sensing location.

D. Other Implementation Details

1. Terms

The detailed description contained herein is represented partly in terms of processes and symbolic representations of operations by a conventional computer and/or wired or wireless network. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture, other than as described. Rather, various types of general purpose machines, sensors, transmitters, receivers, transceivers, and network physical layers may be used with any program modules and any other aspects of the invention constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

3. Program

In the preferred embodiment where any steps of the present invention are embodied in machine-executable instructions, the instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention is composed of hardware (sensors, wireless nodes, Repeaters, Base-Station transceiver, data-acquisition control computer) and computer program products which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the software portion of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

7. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A method for monitoring, facilitation of trouble-shooting and problem diagnosis in an Industrial Process, the method comprising:
(a) Installing a plurality of temporary, removable sensors on an Industrial Process;
(b) collecting operational or environmental data associated with the Industrial Process via the plurality of sensors;
(c) communicating the data from the sensors to a Wireless-Node for transmitting the collected data;
(d) communicating the data from the Wireless-Node to a Base-Station located remotely from the sensors;
(e) communicating the data to a general-purpose computer having loaded in memory computer software code portions for controlling the flow of data from the Wireless-Nodes and for storing, querying, reporting, visualizing and analyzing the data for relationships or anomalies among the data; and
(f) removing the plurality of sensors from the Industrial Process.

2. The method of claim 1, further comprising after step (e) and prior to step (f) the general purpose computer having software code portions for integrating the temporary sensor data with data collected from an existing wired process-control system, thereby producing an aggregated data.

3. A method for evaluating the need and/or benefit for new permanent data sensors and/or sensing locations in an Industrial Process, the method comprising:
(a) Installing a plurality of temporary, removable sensors on an Industrial Process;
(b) collecting operational or environmental data associated with the Industrial Process via the plurality of sensors;
(c) communicating the data from the sensors to a Wireless-Node for transmitting the collected data;
(d) communicating the data from the Wireless-Node to a Base-Station located remotely from the sensors;
(e) communicating the data to a general-purpose computer having loaded in memory computer software code portions for controlling the flow of data from the Wireless-Nodes and for storing, querying, reporting, visualizing and analyzing the data;
(f) assessing the benefit or business value of the temporary sensors or alternate sensing locations; and
(g) removing the plurality of sensors from the Industrial Process or its related hardware.

4. The method of claim 3, further comprising installing one or more permanent sensors corresponding to one or more of the temporary sensors or sensing locations.

5. The method of claim 3, further comprising after step (e) and prior to step (f) the general purpose computer having software code portions for integrating the temporary sensor data with data collected from an existing wired process-control system, thereby producing aggregated data.

6. A system for monitoring, facilitation of trouble-shooting and problem diagnosis in an Industrial Process comprising:
(a) a plurality of sensors for collecting operational or environmental data associated with an Industrial Process, wherein each sensor is temporarily and removably connected to an Industrial Process;
(b) a Wireless-Node in communication with each of the sensors for transmitting the collected data;
(c) a Repeater located remotely from the sensors and Wireless-Nodes for receiving the collected data from the Wireless-Nodes and for re-transmitting the collected data;
(d) a Base-Station located remotely from the sensors, the Wireless-Nodes, and the Repeater for receiving the collected data; and
(e) communicating the data to a general-purpose computer having loaded in memory computer software code portions for controlling the flow of data from the Wireless-Nodes and Repeaters for pre-processing the collected data for further processing.

7. The system of claim 6, where the further processing comprises integrating the collected data from the Base-Station with data collected from an existing wired process-control system, thereby producing aggregated data.

8. The system of claim 6, further comprising a second general purpose computer, operatively connected to the network, having loaded in memory computer software code portions for storing, querying, reporting, visualizing and analyzing the aggregated data for relationships or anomalies among the collected data.

9. The data processing system of claim 6, wherein the sensors are selected from temperature, pressure, flow rate, level, relative humidity, electric current, voltage, power, vibration, rotational speed, velocity, light, sound, contact closures, corrosion rate, pH, ORP, electronic “smell”, composition sensors, and mixtures thereof.

10. The system of claim 6, further comprising having loaded in memory of a general purpose computer comprising the first general purpose computer, the second general purpose computer, or mixtures thereof, computer software code portions for determining from the collected data the occurrence of a pre-defined event and, when a pre-defined event occurs, sending an event notification signal over a network to a signal-receiving device.

11. A data processing system for collecting, processing, and responding to a plurality of data generated by a plurality of pieces of Industrial Equipment located within a fixed geographic area, comprising:
(a) a plurality of sensors configured for measuring data useful for operating pieces of Industrial Equipment;
(b) a Wireless-Node operatively connected to at least a portion of the plurality of sensors and configured and adapted for wirelessly transmitting the data from the sensors;
(c) a Base-Station configured for receiving the data transmitted and for passing the data to a primary computer;
(d) a CPU coupled with the primary computer and;
(e) a memory operatively connected to said CPU, said memory containing a program adapted to be executed by said CPU and said CPU and memory cooperatively adapted to perform diagnostic analysis of the data transmitted from the Base-Station.

12. The data processing system of claim 11, wherein the data is selected from temperature, pressure, flow rate, level, relative humidity, electric current, voltage, power, vibration, rotational speed, velocity, light, sound, contact closures, corrosion rate, pH, ORP, electronic “smell”, composition sensors and mixtures thereof.

13. The data processing system of claim 11, further comprising wired sensors proximate to the wireless sensors; aggregating means for aggregating data collected from wired and wireless sensors; and
wherein the CPU and memory is further cooperatively adapted to perform diagnostic analysis of the aggregated data.

14. The system of claim 11, further comprising having loaded in memory of a general purpose computer in communication with the primary computer, computer software code portions for determining from the data the occurrence of a pre-defined event and, when a pre-defined event occurs, sending an event notification signal over a network to a signal-receiving device.

15. A method for monitoring, facilitation of trouble-shooting and problem diagnosis in an Industrial Process comprising:
(a) collecting operational or environmental data associated with an Industrial Process unit via a plurality of sensors, wherein each sensor is temporarily and removably connected to an Industrial Process;
(b) communicating the data from the sensors to a Wireless-Node for transmitting the collected data;
(c) communicating the data from the Wireless-Node to a Base-Station located remotely from the sensors;
(d) communicating the data from the Base-Station to a first general purpose computer having loaded in memory computer software code portions for controlling the flow of data from the Wireless-Nodes and computer software code for storing and querying this data,
(e) communicating the temporary sensor data from the first general-purpose computer to a second general-purpose computer having loaded in memory computer software code portions for integrating the collected data from the first general-purpose computer with data collected from an existing wired process-control system, thereby producing an aggregated data and analyzing the aggregated data for relationships or anomalies among the aggregated data.

16. The method of claim 15, wherein the first general purpose computer and second general-purpose computer are logical distinctions only and are the same physically.

17. The data processing system of claim 15, wherein the sensors are selected from temperature, pressure, flow rate, level, relative humidity, electric current, voltage, power, vibration, rotational speed, velocity, light, sound, contact closures, corrosion rate, pH, ORP, electronic “smell”, composition sensors, and mixtures thereof.

18. A method for collecting, processing, and responding to a plurality of data generated by a plurality of pieces of Industrial Equipment located within a fixed geographic area, comprising:
(a) measuring data useful for operating pieces of Industrial Equipment via plurality of temporary, removable sensors;
(b) wirelessly transmitting the data via a plurality of Wireless-Nodes, one coupled to each sensor;
(c) receiving the data by at least one wireless Repeater;
(d) re-transmitting the data via the wireless Repeater;
(e) receiving the data by a Base-Station; and
(f) communicating the data via a wired network to a primary computer comprising a CPU coupled with the primary computer and a memory operatively connected to said CPU, said memory containing a program adapted to be executed by said CPU and said CPU and memory cooperatively adapted to perform diagnostic analysis of the data communicated from the Base-Station.

19. The method of claim 18, wherein the sensors are selected from temperature, pressure, flow rate, level, relative humidity, electric current, voltage, power, vibration, rotational speed, velocity, light, sound, contact closures, corrosion rate, pH, ORP, electronic “smell”, composition sensors, and mixtures thereof.

20. The method of claim 18, further comprising collecting data from wired sensors disposed proximate to the wireless-enabled sensors; aggregating the data collected from the wired and wireless-enabled sensors; and wherein the CPU and memory of the primary computer is further cooperatively adapted to perform diagnostic analysis of the aggregated data.
